(19) United States
(12) Patent Application Publication
(10) Pub. No.: US 2006/0196484 A1
(43) Pub. Date: Sep. 7, 2006

(54) Capture and burn air heater

(76) Inventors: Alan P. Gill, Batavia, IL (US); David J. Hall, Shakopee, MN (US); Chadwick P. Anderson, New Prague, MN (US)

Correspondence Address: HARNESS, DICKEY & PIERCE, P.L.C., P.O. BOX 828, BLOOMFIELD HILLS, MI, 48303, US

(21) Appl. No.: 11/357,875

(22) Filed: Feb. 17, 2006

Related U.S. Application Data
(63) Continuation-in-part of application No. 11/311,836, filed on Dec. 19, 2005.
Application No. 11/311,836 is a continuation-in-part of application No. PCT/US04/24079, filed on Jul. 27, 2004.
(60) Provisional application No. 60/490,456, filed on Jul. 28, 2003.

(51) Int. Cl. F02M 31/13

(52) U.S. Cl. 123/549

(57) ABSTRACT

An air intake heater having a heating element in a heat transfer relationship with the passageway is positioned between the intake port and a mixing zone of the fresh air and the recirculated exhaust gas. The air intake heater is operable in a cold-start mode to heat fresh air as it passes through the passageway to assist engine starting as well as a capture and burn mode where soot particles entrained in the recirculated exhaust gas are captured. The heating element is operable to burn off the captured soot particles. Additionally, an air intake and exhaust gas recirculation system for an internal combustion engine includes an intake having a fresh air inlet, a recirculated exhaust gas inlet and a passageway terminating at an intake port. The intake port is adapted to be in communication with an engine combustion chamber.

### CROSS-REFERENCE TO RELATED APPLICATIONS

This application is a continuation-in-part of U.S. patent application Ser. No. 11/311,836, filed on Dec. 19, 2005, now pending, which is a continuation-in-part of International Application No. PCT/US2004/024079, filed on Jul. 27, 2004, which claims the benefit of U.S. Provisional Application No. 60/490,456, filed on Jul. 28, 2003. The disclosures of the above applications are incorporated herein by reference.

### BACKGROUND OF THE INVENTION

The present invention relates to an air heater for an internal combustion engine and, more particularly, to an air heater operable to capture and burn hydrocarbon particles which are exhausted from the internal combustion engine.

Demand for cleaner burning internal combustion engines has continued to increase in recent years. This is largely due to the fact that many countries around the world are implementing increasingly strict emission standards for diesel and other internal combustion engines. The burning of hydrocarbon fuels in engines causes the engine to emit oxides of nitrogen (NOx) as well as particles of soot, various hydrocarbons of unburned fuel and oil as well as sulfates and water. Soluble organic fractions (SOF) are made up of the fuel and oil fractions.

Exhaust gas recirculation (EGR) systems have been used for a number of years to reduce NOx emissions. The exhaust gas recirculation system introduces a portion of the exhaust into the intake air stream of the engine. The exhaust gas replaces a portion of the combustion air in the engine, resulting in less oxygen available to enter into the reactions. Introduction of exhaust gas into the intake air stream also lowers the temperature at which combustion occurs. A lower concentration of NOx emissions in the exhaust gas stream results.

However, a trade off exists between NOx reduction and particulate emissions. The more air that is displaced by the recirculated exhaust gas, the less oxygen introduced into the engine, which means more fuel will be unburned. Unburned or partially burned fuel increases the concentration of particulate emissions in the exhaust stream.

Higher concentrations of soot and SOF may cause a variety of detrimental conditions. For example, particles returned to the engine in the recirculated exhaust gas can result in wear because the particles are abrasive. These particles may become entrained within the engine oil causing wear on the piston rings, valves and other parts of the engine. Additionally, the particles may become deposited within intake passageways and/or on intake/exhaust valves to negatively affect the flow and sealing characteristics of the engine.

Certain EGR systems are equipped with coolers operable to cool exhaust gas passing through the EGR line. The EGR cooler increases the charging efficiency of the EGR gas to further reduce NOx emissions. However, the soot, SOF and unburned fuel (late injection is part of a DPF engine strategy) within the exhaust gas combine to form a sticky substance prone to adhere to the surfaces of the cooling fins within the EGR cooler. The efficiency of the cooler can rapidly and permanently degrade as soot and SOF coat the cooling fins. Additionally complicating the matter, the soot, SOF and raw fuel can combine with oil from a closed breather crankcase ventilation system to create an even more unwieldy mixture. An obstructed passageway induces a back pressure in the exhaust line which can affect engine operation and reduce efficiency of the EGR cooler.

A number of devices such as particulate traps, filters and modified exhaust gas recirculation coolers have been provided in an attempt to address the previously discussed concerns. However, none of the systems economically and efficiently address the solution through the use of an air intake heater as provided by the present disclosure.

### SUMMARY OF THE INVENTION

The present disclosure provides an air intake and exhaust gas recirculation system for an internal combustion engine having a combustion chamber. The air intake and exhaust gas recirculation system includes an intake having a fresh air inlet, a recirculated exhaust gas inlet and a passageway terminating at an intake port. The intake port is adapted to be in communication with the combustion chamber. An air intake heater having a heating element in a heat transfer relationship with the passageway is positioned between the intake port and a mixing zone of the fresh air and the recirculated exhaust gas. The air intake heater is operable in a cold-start mode to heat fresh air as it passes through the passageway to assist engine starting as well as a capture and burn mode where particles entrained in the recirculated exhaust gas are captured. The heating element is operable to burn off the captured particles.

An air intake heater for use with an internal combustion engine having an intake passageway, an exhaust passageway and an exhaust gas recirculation line interconnecting the exhaust passageway and the intake passageway is disclosed. The air intake heater includes a heating element adapted to be positioned in communication with the intake passageway and in a heat transfer relationship with a mixture of recirculated exhaust gas and air supply from the intake passageway. The heating element is operable to capture and burn particles suspended within the mixture of air and recirculated exhaust gas.

In another embodiment, an air intake heater includes a heating element adapted to be positioned in heat transfer relationship with a passage downstream from a gas conduit and an intake passageway interconnection. The heating element has first substantially planar spaced apart portions. Each first portion has a leading edge aligned along a first plane. The heating element includes second substantially planar spaced apart portions where each second portion has a leading aligned along a second plane spaced apart from and substantially parallel to the first plane. Each portion of the heating element being aligned with a gap formed between the first portions.

In another aspect, the present disclosure provides a method of operating an air intake heater for an internal combustion engine having an intake passageway and a recirculated exhaust gas line in communication with the intake passageway. The method includes positioning the air intake heater within the air intake passageway downstream from a mixing zone where fresh intake air mixes with the recirculated exhaust gas. The air intake heater is selectively energized to transfer heat to fresh air within the intake passageway to aid engine starting. Particles are captured on the air intake heater while the engine is running. The air intake heater is selectively energized to burn the captured particles.

### DRAWINGS

The drawings described herein are for illustration purposes only and are not intended to limit the scope of the present disclosure in any way.

FIG. 1 is a schematic depicting an exemplary engine in communication with an air intake and exhaust system constructed in accordance with the teachings of the present disclosure;

FIG. 2 is a schematic depicting a control system for the air heaters of the present disclosure;

FIG. 3 is a graph indicating quantities of SOF generated by an exemplary diesel fueled internal combustion engine operating at an ambient temperature of −10° F.;

FIG. 4 is a graph depicting quantities of SOF generated by an exemplary diesel fueled internal combustion engine operating at an ambient temperature of 40° F.;

FIG. 5 is a cross-sectional view depicting an air intake heater having moveable heating elements shown in a restricted position;

FIG. 6 is a cross-sectional view depicting the air intake heater of FIG. 5 having the moveable element oriented at an open position;

FIG. 7 is a cross-sectional view depicting an alternate embodiment air intake heater;

FIG. 8 is a cross-sectional view showing another embodiment air intake heater;

FIG. 9 is a cross-sectional view depicting another alternate embodiment air intake heater;

FIG. 10 is a schematic of an alternate embodiment air intake and exhaust system coupled to an exemplary internal combustion engine; and

FIG. 11 is a schematic depicting an alternate embodiment air intake system coupled to an exemplary internal combustion engine.

### DETAILED DESCRIPTION

The following description of the preferred embodiments is merely exemplary in nature and is in no way intended to limit the present disclosure, application, or uses.

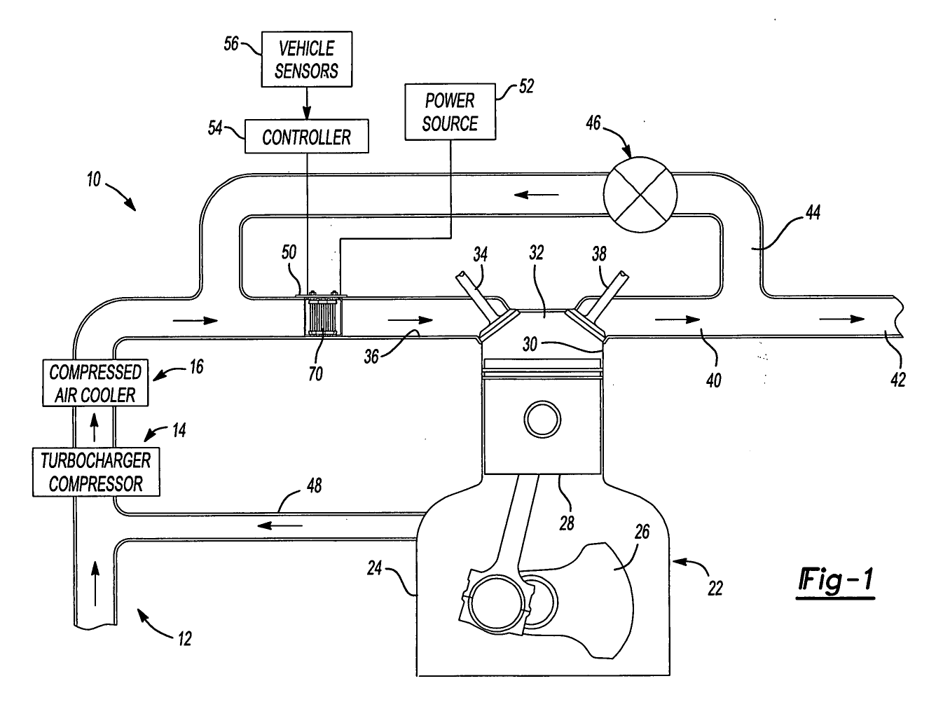

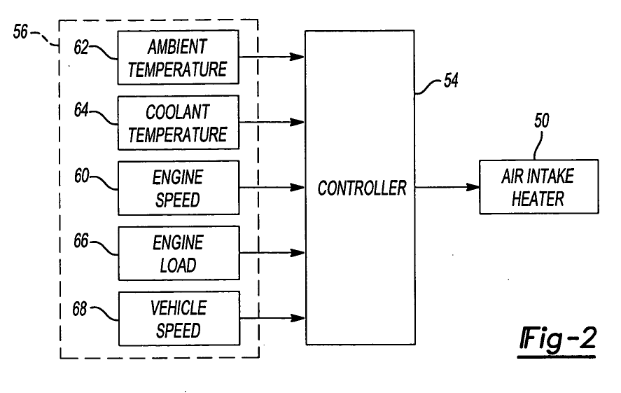

FIGS. 1 and 2 depict an air intake system 10 having a fresh air intake port 12, a turbocharger compressor 14 and a compressed air cooler 16 shown in communication with an exemplary internal combustion engine 22. Engine 22 includes a crankcase 24 rotatably supporting a crankshaft 26. A piston 28 is slidably positioned within a bore 30 of crankcase 24. A combustion chamber 32 is formed on one side of piston 28 within bore 30. An intake valve 34 is positioned within combustion chamber 32 and is selectively moveable between an open and closed position. In the open position, intake air is allowed to flow through an intake passageway 36 into combustion chamber 32. An exhaust valve 38 is positioned within combustion chamber 32 and may be selectively moved between opened and closed positions as well. When the exhaust valve 38 is in the opened position, gasses may be expelled from combustion chamber 32 through an exhaust passageway 40. A portion of the exhaust travels through a tail pipe 42 to a hot side of the turbocharger (not shown) and atmosphere while another portion of the exhaust gasses may travel through an exhaust gas recirculation line (EGR line) 44. The quantity of exhaust gas recirculated and allowed to travel through EGR line 44 is controlled by an EGR valve 46.

A closed crankcase ventilation line 48 interconnects crankcase 24 and intake port 12. During engine operation, some combustion gasses within combustion chamber 32 pass by piston 28 and enter crankcase 24. The gasses are termed blow-by gasses and undesirably pressurize crankcase 24. The vacuum created by compressor 14 draws the blow-by gasses from crankcase 24 and re-introduces the gasses into intake system 10. The blow-by gasses contain oil which may mix with the soot, SOF and unburned fuel previously described.

Fresh incoming air is allowed to enter intake port 12 and mix with recirculated exhaust gas at a location where EGR line 44 connects with intake passageway 36. Downstream of the zone where the fresh air and the recirculated exhaust gas mix, an air intake heater 50 is positioned in communication with intake passageway 36. Air intake heater 50 is electrically coupled to a power source 52 and a controller 54. A plurality of vehicle sensors 56 are operable to provide signals indicative of vehicle operation to controller 54. Controller 54 is programmed to interpret the vehicle sensor data and control operation of air intake heater 50. It is contemplated that air intake heater 50 is operable in at least a cold-start mode, a routine regeneration mode and a special regeneration mode. The air intake heater may also be operable in a cold performance mode.

The cold-start mode will be entered if vehicle sensors 56 indicate that engine 22 is not running as may be indicated by an engine speed sensor 60. Additional data may be provided to controller 54 by an ambient temperature sensor 62, a coolant temperature sensor 64, an engine load sensor 66 and a vehicle speed sensor 68. Depending on the complexity of the control system, controller 54 may enter the cold-start mode by calculating the output from one or more of the sensors listed. Furthermore, controller 54 may be operable to evaluate data from any number of additional sensors deemed necessary to assure proper operation of intake system 20 and engine 22. For example, an exemplary air intake heater and control system is disclosed by PCT/US2004/024079 which is incorporated by reference herein. Other exemplary air intake heaters are described in U.S. Pat. Nos. 6,073,615 and 6,031,204 which are also incorporated by reference.

After engine 22 has been started, controller 54 may energize air intake heater 50 causing the intake heater to operate in the cold performance mode. At this time, intake air continues to be heated to allow the components and fluid circulating within engine 22 to become warmed to a proper operating temperature. Operation of the air intake heater in the cold performance mode was described in previously incorporated publication PCT/US2004/024079 where the cold performance mode was termed a “post heat” mode of heater operation.

While engine 22 is running, EGR valve 46 allows at least a portion of the exhaust gasses to be reintroduced into the air intake stream. Specifically, exhaust gasses enter intake passageway 36 and combustion chamber 32 by passing intake valve 34 during an intake stroke. As previously described, the exhaust gasses include particles of soot, unburned fuel and soluble organic fractions (SOF). The mixture of soot, unburned fuel, SOF and oil forms a very “sticky” mixture that has tendency to adhere against the surfaces of intake passageway 36 and intake valve 34. Particles that did not adhere to the components of the intake system, enter combustion chamber 32 and may prematurely cause wear to the walls of the cylinder and/or rings coupled to piston 28.

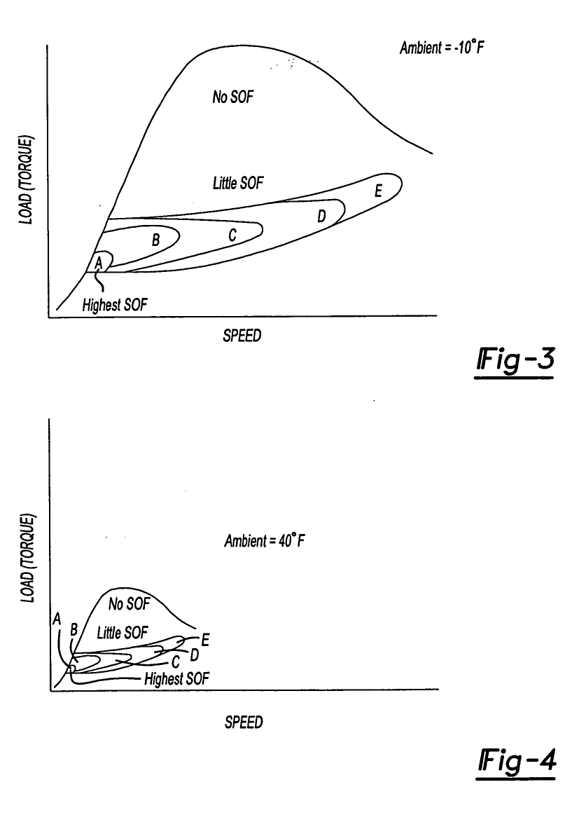

FIG. 3 depicts a SOF map showing conditions at which relatively high quantities of SOF are generated based on engine load and engine speed. The SOF map of FIG. 3 represents an engine operating at a relatively low ambient temperature of −10° F. FIG. 4 shows a similar SOF map indicating engine operating conditions where relatively high quantities of SOF are created at an ambient temperature of 40° F. It should be noted that increased SOF is created at lower ambient temperatures. Furthermore, varying quantities of SOF are created depending on the load and engine operating speed. The SOF maps depict zones A-E where the most SOF is generated when engine 22 operates with zone A. Progressively decreasing quantities of SOF are generated at zones B-E.

To reduce the quantity of soot, unburned fuel, SOF and oil allowed to enter combustion chamber 32, air intake heater 50 is configured to capture and burn the undesirable components of the recirculated exhaust gas and crankcase gas. A number of air intake heater embodiments operable to capture and burn soot, SOF, unburned fuel and oil will be described. After air intake heater 50 has captured particles from the exhaust gas, the controller 54 may operate air intake heater 50 in the routine regeneration mode. During this mode of operation, controller 54 determines that engine 22 has been operated a predetermined amount of time since the last regeneration and that based on running time a sufficient quantity of soot, SOF, oil and/or unburned fuel has been captured by air intake heater 50. While engine 22 is running, controller 54 causes energy from power source 52 to be supplied to air intake heater 50 to burn the captured particles off of a heating element 70 of air intake heater 50. The quantity of energy output from air intake heater 50 and the duration of the burn are determined based on the size and volumetric flow rate characteristics of the particular engine 22 and air intake system 20. After the predetermined duration of engine running time has elapsed, controller 54 energizes air intake heater 50 to enter a routine regeneration mode once again.

Controller 54 also performs multiple calculations using SOF maps such as the maps depicted in FIGS. 3 and 4. Controller 54 calculates the amount of time engine 22 operates within each of zones A-E and determines when the next burn should occur. One strategy includes having the controller estimate the quantity of particles captured on air intake heater 50 during vehicle operation. Once a predetermined quantity is met, controller 54 causes air intake heater 50 to enter a special regeneration mode to burn off the captured particles. Other strategies could include initiating a burn or regeneration when the engine has operated within certain zones for certain periods of total accumulated time.

It is known that relatively high quantities of SOF are generated during low load, low temperature engine operation. This condition is likely to occur during initial vehicle start-up when a trucker begins his day and allows the vehicle to idle for a relatively long period of time. Accordingly, it may be desirable for controller 54 to cause air intake heater 50 to enter the special regeneration mode after engine 22 has operated at idle conditions for a predetermined amount of time.

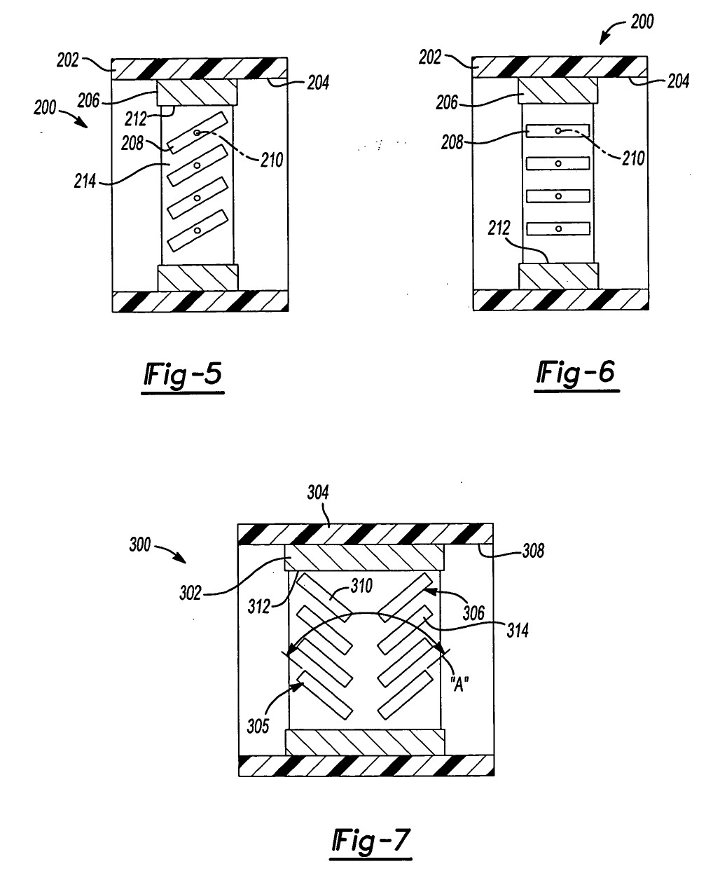

FIGS. 5 and 6 show an exemplary air intake heater embodiment identified at reference numeral 200. Air intake heater 200 is positioned within an air intake tube 202 having a passageway 204. Air intake heater 200 includes a frame 206 and a plurality of movable heating elements 208. Each heating element 208 is rotatable about an axis 210 between a substantially restricted position as shown in FIG. 5 and a substantially open position as shown in FIG. 6. In the substantially restricted position of FIG. 5, each heating element 208 is rotated to at least partially close off an aperture 212 extending through air intake heater 200. When heating elements 208 are in the substantially restricted position, a greater quantity of air is forced into contact with the surfaces of heating elements 208. During this mode of operation, a large percentage of particles are captured on heating elements 208. Accordingly, heating elements 208 may be rotated to the substantially restricted position during engine operating conditions more likely to produce SOF. Sufficient gaps 214 exist between elements 208 while in the restricted position to allow air to pass by heating elements 208 at a flow rate required during low load engine operations where the air flow rates are low and very low restriction exists.

During maximum engine load conditions, heating elements 208 are rotated to the position shown in FIG. 6. In this position, each heating element 208 is substantially parallel to one another and parallel to the direction of air flow passing through aperture 212. FIG. 6 represents a heating element position where the flow through intake tube 202 is least restricted. The movable set of heating elements 208 provide the benefit of capturing a large quantity of particles while in the most restrictive position while also being operable to meet engine manufacturers' standards regarding intake air flow under maximum load conditions. It should be appreciated that air intake heater 200 may enter any one of the cold-start, routine regeneration or special regeneration modes while heating elements 208 are positioned in the substantially restricted position, the substantially open position or at a position intermediate the two extremes.

FIG. 7 depicts another air rise intake heater embodiment at reference numeral 300. Air intake heater 300 includes a frame 302 coupled to an intake tube 304. Air intake heater 300 includes a first heating element 305 and a second heating element 306 positioned in heat transfer relationship with air passing through a passageway 308 extending through intake tube 304. First heating element 305 includes a plurality of spaced apart portions 310 positioned at an angle to the direction of air flow passing through an aperture 312 extending through air intake heater 300. First heating element 305 disrupts the flow of air through aperture 312 and transfers heat to air passing thereby.

Second heating element 306 includes a plurality of spaced apart portions 314 fixed to frame 302. Portions 314 are positioned at a different angle than portions 310 relative to the flow of intake air. Portions 314 are positioned to maximize the capture of particles attempting to pass through aperture 312. The combination effect of the positioning of first heating element 305 and second heating element 306 is taken into account to assure that a minimum flow rate of air through intake tube 304 may be met during a maximum engine load condition. In one embodiment, like portions of first heating element 305 and second heating element 306 form an angle “A” ranging between 30-120 degrees.

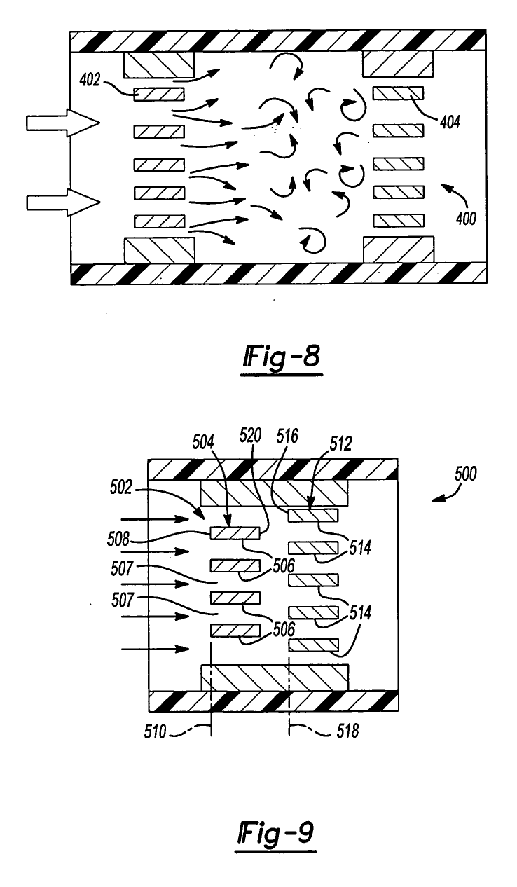

FIG. 8 depicts another alternate embodiment air intake heater 400 having a first heating element 402 and a second heating element 404. First heating element 402 is spaced apart from second heating element 404 such that air flow entering the downstream second heating element 404 is substantially turbulent in nature. Heat transfer from second heating element 404 to the air is more efficient within a turbulent air stream. Additionally, soot, SOF and unburned fuel particles are more likely to adhere to the surfaces of second heating element 404 due to the reduced air stream velocity and turbulent nature of the flow. Therefore, this embodiment attempts to maximize the heat content of the air entering the combustion chamber when operating in the cold-start mode and maximize the quantity of particles captured and burned during regeneration modes.

FIG. 9 shows an air intake heater 500 having a heating element 502. Heating element 502 has a first portion 504 having substantially planar sections 506. Planar sections 506 are spaced apart from one another to define gaps 507. Each planar section 506 includes a leading edge 508 aligned along a first plane 510. A second portion 512 of heating element 502 includes substantially planar sections 514. Planar sections 514 are also spaced apart from one another. Each planar section 514 includes a leading edge 516 aligned along a second plane 518.

Intake air travels along the direction of the arrows depicted in FIG. 8. The flow of intake air is impeded by leading edges 508 of first portion 504. Air continues to travel across the width of first portion 504 where heat is transferred from heating element 502 to the air passing thereby. Leading edges 516 of second portion 512 are positioned to impede the flow of air passing between individual sections 506 of first portion 504. By positioning sections 514 of second portion 512 in line with the gaps 507 defined by sections 506 of first portion 504, particulate capture is maximized because the air is required to follow a circuitous path around various sections of heating element 502.

It should be appreciated that while FIG. 9 depicts only two planes of leading edges, a single heating element or multiple heating elements may be arranged to provide a more convoluted path for the air to follow as it passes through air intake heater 500. Furthermore, FIG. 9 depicts leading edges 516 aligned along second plane 518 as being spaced apart from a plurality of trailing edges 520 of first portion 504. Other embodiments having sections 506 and sections 514 that at least partially overlap one another to form a nested or intergiditated arrangement are contemplated.

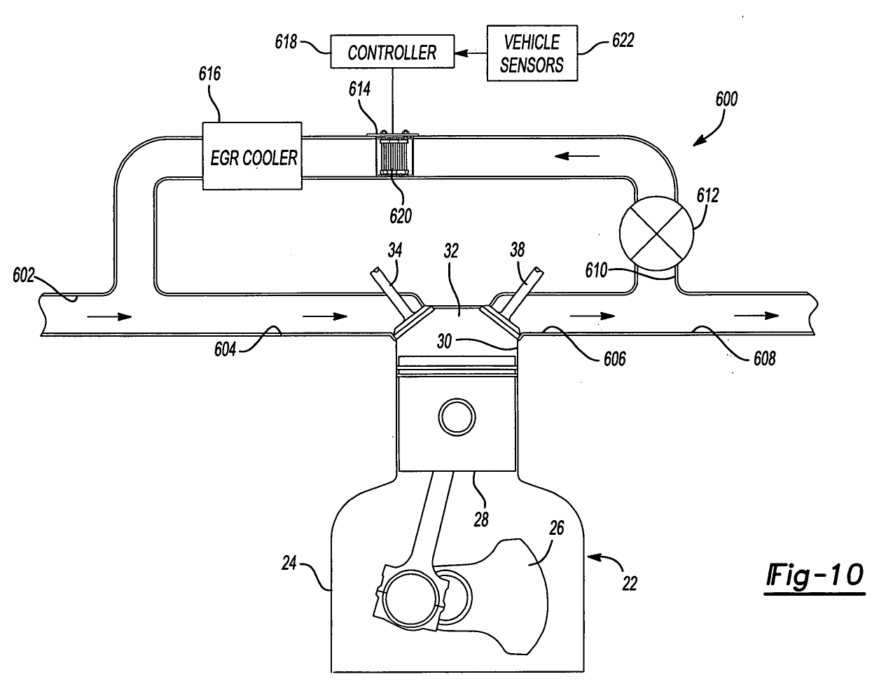

FIG. 10 depicts an alternate embodiment intake and exhaust arrangement 600 coupled to previously described engine 22. Intake and exhaust arrangement 600 includes a fresh air inlet 602 in communication with an intake tube 604. Intake tube 604 is in communication with intake valve 34 and selectively in communication with combustion chamber 32 when intake valve 34 is in the open position. An exhaust passageway 606 is in communication with exhaust valve 38 and in selective communication with combustion chamber 32 when exhaust valve 38 is in the open position. Exhaust passageway 606 provides combustion exhaust gasses to an exhaust pipe 608 and an exhaust gas recirculation line 610. An exhaust gas recirculation valve 612 selectively allows a portion of the exhaust gasses to pass further down exhaust gas recirculation line 610 in the direction of the arrows shown in FIG. 10.

An air heater 614 is positioned in communication with exhaust gasses passing through exhaust gas recirculation line 610. Air heater 614 is operable to increase the temperature of the recirculated exhaust gasses before entry into an exhaust gas recirculation cooler 616. Air heater 614 is operable to vaporize soot, SOF and unburned fuel prior to entry into exhaust gas recirculation cooler 616 such that particles do not adhere to the cooling fins (not shown) of EGR cooler 616. As mentioned earlier, the particles within recirculated exhaust gas have a tendency to adhere to the cooling fins of EGR cooler 616. The particles may rapidly accumulate to detrimentally affect EGR cooler 616 by reducing its heat transfer capability as well as restricting the amount of gas allowed to pass thereby.

Air heater 614 is in communication with a controller 618 configured to selectively energize air heater 614 to burn off particles captured on a heating element 620 of air heater 614. As described in detail regarding controller 54, controller 618 may accept signals from a number of vehicle sensors 622 to best assure proper operation of EGR cooler 616 and engine 22. It should be appreciated that while air heater 614 is shown separate and spaced apart from EGR cooler 616, air heater 614 may be constructed as an integral part of EGR cooler 616 without departing from the scope of the present disclosure.

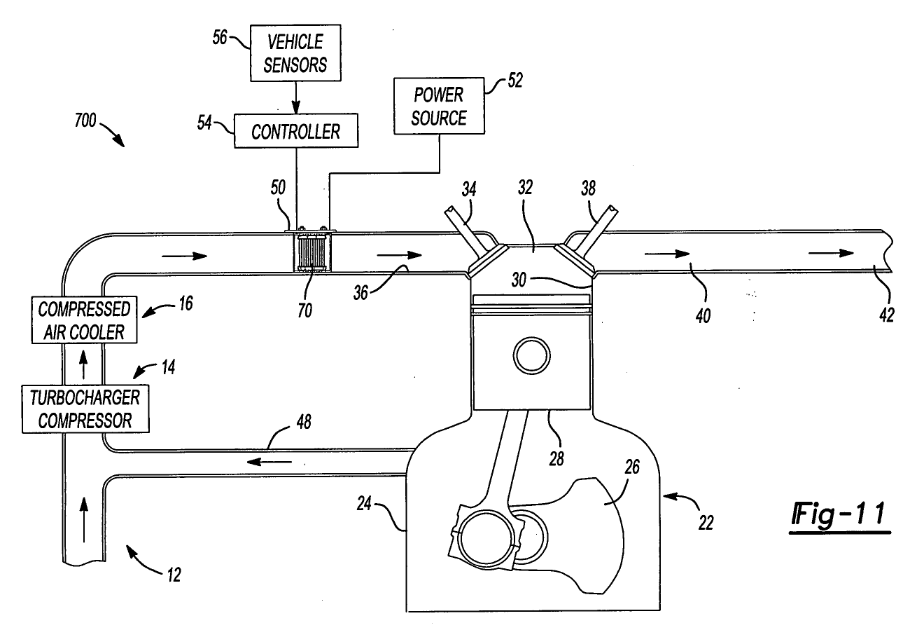

FIG. 11 depicts an alternate embodiment intake arrangement 700 coupled to previously described engine 22. Intake 700 is substantially similar to the arrangement depicted in FIG. 1 except that an exhaust gas recirculation circuit is not provided. Accordingly, like elements will retain their previously introduced reference numerals. Air heater 50 is operable in any one or more of the cold start mode, cold performance mode, routine regeneration mode or the special regeneration mode previously described. Because intake 700 does not include an exhaust gas recirculation line, operation of air heater 50 in one of the regeneration modes includes capturing and burning particles mixed with or solely including oil entrained within crankcase ventilation line 48.

For any of the aforementioned heaters or systems, it is contemplated to electrostatically charge the elements of the heater to further expedite the capture of the particles within the exhaust gas. In these enhanced embodiments, controller 54 or controller 618 are operable to selectively apply an electrostatic charge. Once a predetermined amount of soot, SOF and/or unburned fuel is collected, the air heater is energized to burn off the particles. Furthermore, any one of the air heaters previously described may be controlled by a controller capable of estimating the mass of soot, SOF and/or unburned fuel present on a heating element. Once the mass of particles exceed a predetermined value, the controller initiates a burn by energizing the heating element for a predetermined amount of time.

What is claimed is:

1. An air intake heater for use with an internal combustion engine having an intake passageway, an exhaust passageway and an exhaust gas recirculation line interconnecting the exhaust passageway and the intake passageway, the air intake heater comprising:
a heating element adapted to be positioned in communication with the intake passageway and in a heat transfer relationship with a mixture of recirculated exhaust gas and air supplied from the intake passageway, the heating element being operable to capture and burn particles suspended within the mixture of air and recirculated exhaust gas.

2. The air intake heater of claim 1 wherein the heating element has portions movable between first and second positions, said portions relatively restricting more air flow when in the first position than in the second position.

3. The air intake heater of claim 2 wherein the moveable portions are positioned substantially parallel to the direction of air flow when in the second position.

4. The air intake heater of claim 3 wherein during low speed engine operation the moveable portions are in the first position to capture a maximum amount of particles from the recirculated exhaust gas passing through the air heater, the moveable portions minimally restricting the very low air flows experienced during low engine speed.

5. The air intake heater of claim 1 wherein the heater element includes first and second sections adapted to be positioned in a heat transfer relationship with the intake passageway, the first heating element section having substantially planar portions aligned with one another, at least two of the planar portions being positioned at an angle to the direction of air flow, the second heating element section having substantially planar portions aligned with one another, at least two of the planar portions of the second heating element section being positioned at a different angle to the direction of air flow.

6. The air intake heater of claim 5 wherein at least one planar portion of the first heating element section forms an angle with at least one planar portion of the second heating element section ranging between thirty and one hundred and twenty degrees.

7. The air intake heater of claim 1 wherein the particles captured include soot, SOF, oil or unburned fuel.

8. The air intake heater of claim 1 wherein the heating element is adapted to be in communication with blow-by gasses from the engine.

9. An air intake and exhaust gas recirculation system for an internal combustion engine having a combustion chamber, the air intake and exhaust gas system comprising:
an intake having a fresh air inlet, a recirculated exhaust gas inlet and a passageway terminating at an intake port, the intake port being adapted to be in communication with the combustion chamber; and
an air intake heater having a heating element being in a heat transfer relationship with the passageway and being positioned between the intake port and a mixing zone of the fresh air and the recirculated exhaust gas, the air intake heater being operable in a cold-start mode to heat fresh air as it passes through the passageway to assist engine starting as well as a capture and burn mode where particles entrained in the recirculated exhaust gas are captured by the heating element and the heating element is operable to burn off the captured particles.

10. The air intake and exhaust gas recirculation system of claim 9 further including a controller operable to selectively operate the air heater in one of the cold-start and capture and burn modes.

11. The air intake and exhaust gas recirculation system of claim 10 further including a plurality of vehicle sensors operable to output signals indicative of vehicle operating conditions to the controller, the controller being operable to determine the air intake heater operating mode based on the sensor signals.

12. The air intake and exhaust gas recirculation system of claim 11 wherein the plurality of vehicle sensors includes an engine speed sensor.

13. The air intake and exhaust gas recirculation system of claim 12 wherein the plurality of vehicle sensors includes an ambient temperature sensor.

14. The air intake and exhaust gas recirculation system of claim 11 wherein the plurality of vehicle sensors includes a sensor operable to output a signal indicative of engine load.

15. The air intake and exhaust gas recirculation system of claim 10 wherein the controller is operable to sum the operating time at which the engine operates within predetermined zones of engine speed and engine load, the controller operating the heater based on the summer operating time.

16. The air intake and exhaust gas recirculation system of claim 9 further including a crankcase ventilation line in communication with the fresh air inlet, the air intake heater being operable to capture and burn oil particles within crankcase gasses flowing through the crankcase ventilation line.

17. The air intake and exhaust gas recirculation system of claim 16 further including a turbocharger compressor and a compressed air cooler positioned upstream of the air intake heater.

18. The air intake and exhaust gas recirculation system of claim 10 wherein the controller is operable to determine when a predetermined quantity of exhaust gas particles have been captured on the heating element to initiate a burn.

19. The air intake and exhaust gas recirculation system of claim 10 wherein the controller is operable to determine when a predetermined time duration has elapsed since the most recent burn and initiate another burn.

20. The air intake and exhaust gas recirculation system of claim 9 further including an exhaust gas recirculation valve operable to vary an amount of exhaust gas passing through the recirculated exhaust gas inlet.

21. The air intake and exhaust gas recirculation system of claim 9 wherein the air intake heater extends through an aperture formed in the intake and includes a plate coupled to an external surface of the intake.

22. An air intake heater for use in an internal combustion engine having a recirculated exhaust gas conduit in communication with a passageway defined by an intake, the air intake heater comprising:
a heating element adapted to be positioned in a heat transfer relationship with the passage downstream from the gas conduit and intake passageway interconnection, the heating element having first substantially planar spaced apart portions, each first portion having a leading edge aligned along a first plane, the heating element having second substantially planar spaced apart portions, each second portion having a leading edge aligned along a second plane spaced apart from and substantially parallel to the first plane, each portion of the heating element being aligned with a gap formed between the first portions.

23. The air intake heater of claim 22 wherein the first and second heating element portions are oriented substantially parallel to one another and parallel to the direction of air flow.

24. An air intake and exhaust gas recirculation system for use with an internal combustion engine, the intake and exhaust gas recirculation system comprising:
an intake passageway;
an exhaust passageway;
an exhaust gas recirculation line interconnecting the exhaust passageway and the intake passageway;
an air heater having a heating element positioned in communication with the exhaust gas recirculation line and in a heat transfer relationship with recirculated exhaust gas, the heating element being operable to capture and burn soot particles suspended within the recirculated exhaust gas; and
an exhaust gas recirculation cooler positioned in communication with the exhaust gas recirculation line at a location downstream from the heating element, the cooler being operable to reduce the temperature of gas exiting the air heater prior to entry into the intake passageway.

25. The air intake and exhaust gas recirculation system of claim 24 wherein the heating element has portions movable between first and second positions, said portions relatively restricting more air flow when in the first position than in the second position.

26. The air intake and exhaust gas recirculation system of claim 25 wherein the moveable portions are positioned substantially parallel to the direction of air flow when in the second position.

27. The air intake and exhaust gas recirculation system of claim 26 wherein during engine idle the moveable portions are in the first position to capture a maximum amount of particles from the recirculated exhaust gas passing through the air heater, the moveable portions minimally restricting the very low air flows experienced during engine idle.

28. The air intake and exhaust gas recirculation system of claim 27 wherein the heater element includes first and second sections adapted to be positioned in a heat transfer relationship with the intake passageway, the first heating element section having substantially planar portions aligned with one another, at least two of the planar portions being positioned at an angle to the direction of air flow, the second heating element section having substantially planar portions aligned with one another, at least two of the planar portions of the second heating element section being positioned at a different angle to the direction of air flow.

29. The air intake and exhaust gas recirculation system of claim 24 further including a controller operable to selectively energize the air heater in the capture and burn mode.

30. The air intake and exhaust gas recirculation system of claim 29 further including a plurality of vehicle sensors operable to output signals indicative of vehicle operating conditions to the controller, the controller being operable to determine the air heater operating mode based on the sensor signals.

31. The air intake and exhaust gas recirculation system of claim 29 wherein the controller is operable to determine when a predetermined quantity of exhaust gas particles have been captured on the heating element to initiate a burn.

32. An air intake heater for use with an internal combustion engine having an intake passageway, a crankcase and a crankcase ventilation line interconnecting the crankcase and the intake passageway, the air intake heater comprising:
a heating element adapted to be positioned in communication with the intake passageway and in a heat transfer relationship with a mixture of crankcase gas and air supplied from the intake passageway, the heating element being operable to capture and burn particles suspended within the mixture of air and crankcase gas.

33. The air intake heater of claim 32 wherein the particles captured include oil from the crankcase.

34. A method of operating an air intake heater for an internal combustion engine having an intake passageway and a recirculated exhaust gas line in communication with the intake passageway, the method comprising:
positioning the air intake heater within the air intake passageway downstream from a mixing zone where fresh intake air mixes with recirculated exhaust gas;
selectively energizing the air intake heater to transfer heat to fresh air within the intake passageway to aid engine starting;
capturing soot on the air intake heater while the engine is running; and
selectively energizing the air intake heater to burn the captured soot.

35. The method of claim 34 further including collecting vehicle operating information with vehicle sensors, outputting signals from the vehicle sensors to a controller and controlling operation of the air intake heater based on the vehicle sensor signals.

36. The method of claim 35 further including moving rotatable portions of the air intake heater to maximize the quantity of soot captured.
